(19) United States
(12) Patent Application Publication
(10) Pub. No.: US 2007/0106566 A1
(43) Pub. Date: May 10, 2007

(54) Method and arrangement for providing automated searching service on the real estate market

(76) Inventors: Mikko Ranin, Espoo (FI); Jussi Nurmio, Helsinki (FI); Esa Rauhala, Helsinki (FI)

Correspondence Address: YOUNG & THOMPSON, 745 SOUTH 23RD STREET, 2ND FLOOR, ARLINGTON, VA, 22202, US

(21) Appl. No.: 11/592,245

(22) Filed: Nov. 3, 2006

(30) Foreign Application Priority Data
Nov. 4, 2005 (FI) 20051118

(51) Int. Cl. G06Q 30/00

(52) U.S. Cl. 705/26

(57) ABSTRACT

The invention relates to a method and a system for providing an automated searching service operating in a data network on a real estate market. A potential buyer looking for a suitable object is represented by a purchase advertisement provided with certain constraint requirements. A potential seller selling a certain object is represented by a sales advertisement provided with the distinguishing features of the object on sale. The purchase advertisement and the sales advertisement are stored in a data base. The automated searching service is symmetrical such that the potential seller is offered an opportunity to receive a report presenting the purchase advertisements selected on the basis of predefined requirements and, correspondingly, the potential buyer is offered an opportunity to receive a report presenting the sales advertisements selected on the basis of predefined requirements.

### FIELD OF THE INVENTION

The invention relates to a method and an arrangement for providing an automated searching service on the real estate market so that the automated searching service is offered to potential buyers for searching for objects on sale and the automated searching service is offered to potential sellers for searching for the potential buyers.

### BACKGROUND OF THE INVENTION

Conventional instruments for matching the potential buyers and sellers on the real estate and housing market include newspaper advertisements, advertisements published in a data network, such as the Internet, or presentations organized by the person selling the real estate or dwelling, or his or her agent. On the present real estate and housing market, there are a lot of objects on sale at the same time in growth centres, in particular. Because of the large number of objects being offered by means of the newspaper advertisements, in particular, there is a considerable risk that the potential buyer fails to see an object on sale, which he or she might be interested in, particularly. Furthermore, the amount of information about the object on sale in the newspaper advertisements is very small. Consequently, the potential buyer looking for a suitable object by means of the newspaper advertisements or generally surveying the market conditions must pay a large number of visits to the presentations, which require time and money. The present data network technology, such as the Internet, can be used to improve the situation, for example, so that the potential buyer looking for a suitable object or generally surveying the market conditions can define constraint requirements, such as the location area, the upper price limit, the surface area of the building or the dwelling, etc., which the object on sale should meet. Then, the potential buyer can perform a retrieval, which only yields the sales advertisements of those objects on sale placed in the data network, which meet the above-mentioned constraint requirements. In the data network, it is possible to show a considerably larger number of photographs and other information about the object on sale than in the conventional newspaper advertisements. In that case, the potential buyer can reduce the number of objects in advance and, through this, reduce the number of visits to the presentations, which require time and money. It is also possible for the buyer to place in the data network a purchase advertisement provided with the constraint requirements he or she chooses.

Naturally, the potential buyer looking for a suitable object or generally surveying the market conditions would achieve the most informative results by paying a large number of visits to the presentations. In that case, the potential buyer would see a large number of objects in the best possible way and, at the same time, maintain extensive and real-time knowledge of the market, concerning the prevailing price level and any interesting objects on sale. On the basis of the knowledge of the market obtained in the presentations, the potential buyer can contact the quarters selling the objects of interest or their agents for detailed negotiations. The quarter selling the object or their agent could, in turn, survey a large number of potential buyers to obtain a real-time view of the potential buyers, who might be interested in the particular object on sale. Through this, the quarter selling the object, or their agent, can contact the potential buyers for detailed negotiations. Thus, the activity is characterized in a symmetrical aspect so that the potential buyers would maintain a more or less formal data base of objects of interest and, correspondingly, the quarters selling the objects would maintain a more or less formal data base of the potential buyers. From the viewpoint of the potential buyer, one advantage of the survey of the market conditions based on the data network compared with the visits to the presentations is its quickness and economic efficiency, whereby the potential buyer is able to survey the market conditions to a considerably larger extent than by merely visiting the presentations. However, the methods and the systems according to the known technology, based on the data network, do not provide the symmetry as described above so that the potential buyers could maintain a real-time view of the objects of interest through the data network and, correspondingly, the potential sellers could maintain a real-time view of the potential buyers through the data network.

Publication US 2002/0082964 A1 describes a system, wherein the potential seller may place a sales advertisement, which is provided with distinguishing features, on the home page of the real estate agent in the data network and, correspondingly, the potential buyer can place a purchase advertisement provided with the constraint requirements on the home page of the real estate agent. The potential buyer can contact the potential seller directly for further negotiations. However, to follow the changing supply, the buyer must actively retrieve from the data network the objects that are on sale at each time. In the method described in publication U.S. Pat. No. 5,664,115, the activity is dissymmetrical so that, in the method, the potential buyer is offered an opportunity to compile a list of objects on sale he or she is interested in, and the information of the potential buyer is transferred to those potential sellers only, the sales objects of whom the potential buyer has selected in the said list. In that case, the information of the potential buyer, who might be interested in a given object on sale but who has not noticed that particular object on sale because of the large number of objects on sale, for example, or for another reason, is not transmitted to the quarter selling the said object.

The systems according to the known technology are characterized in that the potential seller selling a given object and, correspondingly, the potential buyer looking for a suitable object must often show considerable activity and diligence to improve their knowledge of the market. For private persons, in particular, the real estate or dwelling transaction is such a major one that one or both parties are often insecure about their adequacy of the knowledge of the market in relation to the subjective significance of the transaction in progress. Consequently, there is a considerable demand for methods and systems, which can be used to offer the potential buyers and the potential sellers easier ways of improving their knowledge of the market.

### SUMMARY OF THE INVENTION

The purpose of the invention is to provide a new method for offering an automated searching service on the real estate market, based on the data network, so that the potential buyers are offered the automated searching service to search for the objects on sale, and the potential sellers are offered the automated searching service to search for prospective buyers. Another object of the invention comprises a system for offering the automated searching service based on the data network on the real estate market. A further object of the invention is a computer program for offering the automated searching service based on the data network on the real estate market.

In the method according to the invention, a situation is provided by means of the data network, wherein the potential buyers are looking for suitable objects and/or generally merely surveying the market conditions, and the potential sellers are looking for the potential buyers and/or just generally surveying the market conditions. In the activities implemented through the data network, the actors are not physical persons but the sales advertisements and the purchase advertisements placed by them in the data network. A corresponding activity between physical persons comes into being, for example, when a large number of potential buyers visit a great number of presentations, where the potential buyers meet the potential sellers and/or their agents. In the activity over the data network, the potential buyer is represented by a purchase advertisement provided with certain constraint requirements, stored in a data base, and the potential seller is represented by a sales advertisement provided with the distinguishing features of the object on sale, stored in the data base. From the points of view of the potential buyer and the potential seller, the activity is symmetrical in that the potential seller is offered an opportunity to receive a report, when they so desire, presenting the purchase advertisements selected on the basis of the predefined requirements and, correspondingly, the potential buyer is offered an opportunity to receive a report, when they so desire, presenting the sales advertisements selected on the basis of the predefined requirements.

It should be noted that one potential buyer can file several purchase advertisements provided with various constraint requirements. Correspondingly, several sales advertisements can be filed for one object on sale, which may differ from one another with respect to one or more distinguishing features, such as the asking price and/or the schedule of vacancy.

The distinguishing feature of the object on sale in this document may refer to both a property of the object, such as the net floor area, and any information, such as the asking price, attached to the object by the potential seller. Correspondingly, the constraint requirement may refer to both a property of the object to be searched for and any information, such as the highest price acceptable, attached to the object by the potential buyer.

A method according to the invention for providing a searching service operating in a data network on a real estate market is characterised in that the method comprises:

as a response to placing a sales advertisement provided with one or more distinguishing features of an object on sale, said sales advertisement is stored in a data base,

as a response to placing a purchase advertisement provided with one or more constraint requirements of an object being searched for, said purchase advertisement is stored in the data base,

on the basis of the combined effect of at least one distinguishing feature related to said sales advertisement and at least one constraint requirement related to said purchase advertisement, it is at least partly determined whether a piece of information expressing the existence of said purchase advertisement is presented as a response to a reporting request related to said sales advertisement, and

on the basis of the combined effect of at least one distinguishing feature related to said sales advertisement and at least one constraint requirement related to said purchase advertisement, it is at least partly determined whether a piece of information expressing the existence of said sales advertisement is presented as a response to a reporting request related to said purchase advertisement.

A system according to the invention for providing a searching service operating in a data network on a real estate market is characterized in that the system comprises:

an advertisement data base,

a sales advertisement developer for producing a sales advertisement provided with one or more distinguishing features of the object on sale in said advertisement data base,

a purchase advertisement developer for producing a purchase advertisement provided with one or more constraint requirements of the object being searched for in said advertisement data base,

a seller's report developer for producing a sales report corresponding to said sales advertisement,

a buyer's report developer for producing a buyer's report corresponding to said purchase advertisement, and

a comparing element, which is arranged to at least partly determine on the basis of the combined effect of at least one distinguishing feature related to said sales advertisement and at least one constraint requirement related to said purchase advertisement, whether the piece of information expressing the existence of said purchase advertisement is shown in said seller's report and whether the piece of information expressing the existence of said sales advertisement is shown in said buyer's report.

A computer program according to the invention stored in a processor readable means for providing a searching service operating in a data network on a real estate market is characterized in that the computer program comprises:

a programmatic means for producing a sales advertisement provided with one or more distinguishing features of the object on sale in the advertisement data base,

a programmatic means for producing, in the advertisement data base, a purchase advertisement provided with one or more constraint requirements of the object being searched for,

a programmatic means for producing a seller's report corresponding to said sales advertisement,

a programmatic means for producing a buyer's report corresponding to said purchase advertisement, and

a programmatic means for at least partly determining, on the basis of the combined effect of at least one distinguishing feature related to said sales advertisement and at least one constraint requirement related to said purchase advertisement, whether the piece of information expressing the existence of said purchase advertisement is printed in said seller's report, and whether the piece of information expressing the existence of said sales advertisement is printed in said buyer's report.

The various embodiments of the invention are characterized in that which is presented in the dependent claims.

The invention provides considerable advantages:

the method and the system according to the invention offer the potential seller a comfortable way to survey the interest of potential buyers towards the object on sale and, through that, to determine the market value of the object and/or improve their knowledge of the market without having to arrange presentations at the initial stage and/or actively follow the purchase advertisements in newspapers, data networks or other media, and the sales advertisements of other objects,

the method and the system according to the invention offer the potential buyer a comfortable way to look for a suitable object and/or survey the market conditions without having to actively follow the sales advertisements in newspapers, data networks or other media, and the purchase advertisements placed by other potential buyers.

The exemplary embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### SHORT DESCRIPTION OF THE DRAWINGS

In the following, the invention is described in detail with reference to the preferred embodiments shown as examples, and the appended drawings, in which:

FIG. 1 shows a state machine diagram of the method according to one embodiment of the invention for offering the automated searching serviced based on the data network on the real estate market;

FIG. 2 shows the principle of the sales advertisement used in the method according to one embodiment of the invention;

FIG. 3 shows the principle of the purchase advertisement used in the method according to one embodiment of the invention;

FIG. 4 shows the system according to an embodiment of the invention for offering the automated searching service based on the data network on the real estate market;

FIG. 5 shows the hardware that can be used to implement the system according to an embodiment of the invention for offering the automated searching service based on the data network on the real estate market.

### DETAILED DESCRIPTION OF THE EMBODIMENTS OF THE INVENTION

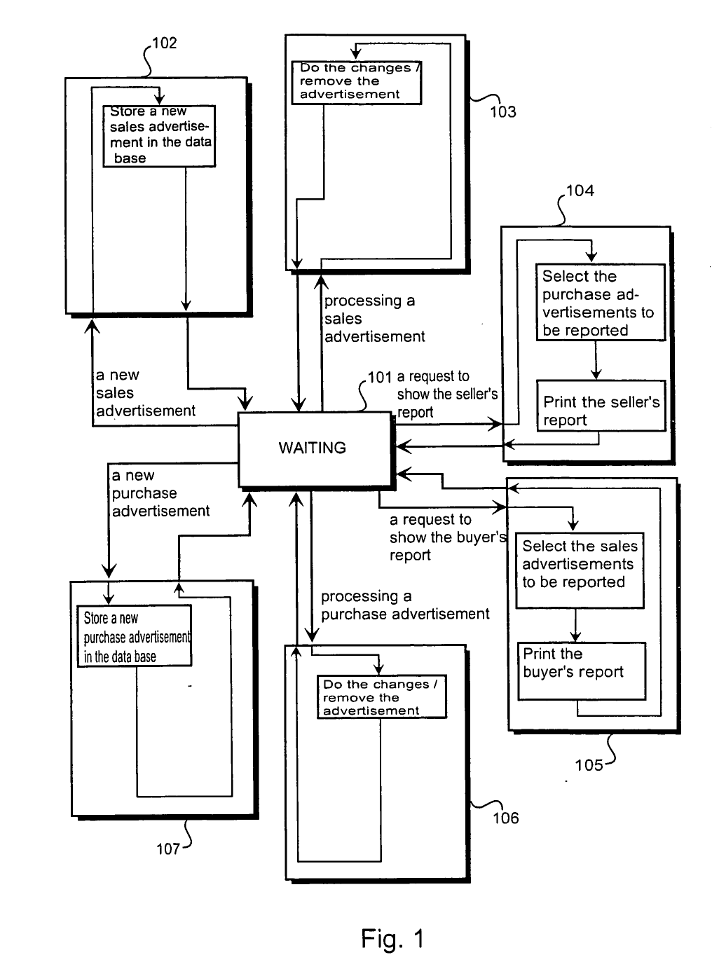

FIG. 1 shows a state machine diagram of the method according to an embodiment of the invention for offering the automated searching service based on the data network on the real estate market. State 101 is a wait state and the states 102 to 107 are operating states. One goes to the wait state from the operating states and the system remains in the wait state until an impulse comes, routing the system to one of the operating states 102 to 107. The impulses include placing a new sales advertisement into the system, placing a new purchase advertisement into the system, a processing procedure of an existing sales advertisement, a processing procedure of an existing purchase advertisement, a request to show a seller's report, and a request to show a buyer's report. After entering the operating state 102 to 107, the functions associated with the said operating state are performed, after which the system automatically returns to the wait state 101.

One enters the operating state 102, when the potential seller places a new sales advertisement into the system. The sales advertisements are processed as logical objects so that each sales advertisement has an identifying data item, by means of which it can be distinguished from the other sales advertisements. The identifying data item can be, for example, an identification number, which a device, such as a server computer in the data network forms when receiving the new sales advertisement. Another alternative is that the potential seller forms the identifying data item. In that case, the device receiving the sales advertisement checks that the suggested identifying data item is not the same as that of a sales advertisement placed earlier. When needed, the receiving device asks the potential seller to form a new suggestion for the identifying data item. The sales advertisement in question, comprising the said identifying data item, the distinguishing features of the object on sale, and any other information associated with the sales advertisement in question, is stored in the data base of the system.

One enters the operating state 107, when the potential buyer places a new purchase advertisement into the system. The purchase advertisements are processed as logical objects so that each purchase advertisement has an identifying data item, by means of which it can be distinguished from the other purchase advertisements and which can be formed by a similar procedure as the identifying data item of the sales advertisement. The purchase advertisement in question, comprising the said identifying data item, the constraint requirements, and any other information associated with the said purchase advertisement, is stored in the data base of the system.

One enters the operating state 103, when the potential seller starts the procedures related to the sales advertisement they have placed earlier. The system can identify the potential seller, for example, by means of a conventional user identifier password identification, whereby outsiders can be prevented from accessing the sales advertisement placed by a certain potential seller. Processing the sales advertisement can refer to removing the said sales advertisement from the system, for example, or changing one or more distinguishing features of the sales advertisement or other information related to the sales advertisement.

One enters the operating state 106, when the potential buyer starts the procedures related to the purchase advertisement they have placed earlier. The potential buyer can also be identified by the user identifier password identification. Processing the purchase advertisement may refer to removing the said purchase advertisement from the system, for example, or changing or removing one or more constraint requirements of the purchase advertisement or other information related to the purchase advertisement.

One enters the operating state 104, when the potential seller, who has placed the sales advertisement, produces a request to show the sales report related to the said sales advertisement. As a response to the request to show the sales report, the purchase advertisements are selected from among all the purchase advertisements, which satisfy the selection conditions valid at the time of requesting to show the sales report. The said selection conditions consist of the following factors: 1) the distinguishing features of the sales advertisement under examination should meet the constraint requirements of the purchase advertisement in line according to a predefined minimum standard, 2) presenting the purchase advertisement in the seller's reports is not prohibited on the basis of the information in the purchase advertisement, and 3) presenting the purchase advertisement is not prohibited by the reporting settings valid during the request to show the seller's report. For example, the said predetermined minimum standard can be a demand that no distinguishing feature of the sales advertisement break any constraint requirements presented in the purchase advertisement. A real time seller's report is formed on the basis of the constraint requirements of the selected purchase advertisements and other information, such as the contact information of the potential buyer. The seller's report shows the constraint requirements of each purchase advertisement and any other information, which in the said purchase offer are allowed to be shown to the potential sellers in connection with the seller's reports. A minimum amount of information about the selected purchase advertisement, which can be motioned to be shown, is the information that indicates the existence of the said purchase advertisement. The reporting settings are used to offer the potential seller an opportunity to place a prohibition to display the purchase advertisement shown in the seller's report, preventing the display of the said purchase advertisement in the following seller's reports. This function enables the potential seller to prevent the growth of the seller's report in process of time from placing the sales advertisement. By means of the report settings, the potential seller is also offered an opportunity to predetermine, what kind of information is shown in the seller's report. For example, the potential seller may only want the contact information of the potential buyers in their seller's report, or the potential seller may want to include in their seller's report only the purchase advertisements that have no absolute price limits, which the potential buyer is not willing to exceed. Furthermore, the potential seller may want in their seller's report only the purchase advertisements, which are younger than the age limit set by the potential seller.

One enters the operating state 105, when the potential buyer, who has placed a purchase advertisement, produces a request to show the buyer's report associated with the said purchase advertisement. As a response to the request to show the buyer's report, those sales advertisements are selected from among all the sales advertisements, which satisfy the conditions of selection valid at the time of requesting to show the buyer's report. The said selection conditions consist of the following parts: 1) the distinguishing features of the sales advertisement in line should meet the constraint requirements of the purchase advertisement under examination according to a predefined minimum standard, 2) presenting the sales advertisement in the buyer's reports is not prohibited on the basis of the information in the sales advertisement, and 3) presenting the sales advertisement is not prohibited by the reporting settings valid during the request to show the buyer's report. The said predetermined minimum standard can be, for example, a demand that no distinguishing feature of the sales advertisement break any of the constraint requirements presented in the purchase advertisement. A real time buyer's report is formed on the basis of the distinguishing features of the selected sales advertisements and other information, such as the contact information of the potential seller. The buyer's report presents the distinguishing features of each sales advertisement and other information, which in the said sales advertisement are allowed to be presented to the potential buyers in connection with the buyer's reports. The minimum amount of information about the selected sales advertisement, which can be motioned to be presented, is the information indicating the existence of the sales advertisement in question. By means of the reporting settings, the potential buyer is offered an opportunity to place a prohibition to present the sales advertisement presented in the buyer's report, preventing the showing of the said sales advertisement in the following buyer's reports. This function makes it possible for the potential buyer to prevent the growth of the buyer's report after a lapse of time from placing the purchase advertisement. By means of the report settings, the potential buyer is also offered an opportunity to predefine the kind of information that is presented in the buyer's report. For example, the potential buyer may want in their buyer's report only the contact information of the potential sellers, or the potential buyer may want in their buyer's report only those sales advertisements that do not define an absolute price limit, under which the potential seller is not willing to assign the object under examination. Furthermore, the potential buyer may want in their buyer's report only those sales advertisements, which are younger than the age limit placed by the potential buyer.

In the method according to one embodiment of the invention, a notification of change is transferred through the data network to the possible buyer who has placed a purchase advertisement, when a new sales advertisement is placed in the data base, which satisfies the selection conditions that would be used to select the sales advertisements, if the potential buyer, who had placed the purchase advertisement in question, produced a request to show the buyer's report. The notification of change in question can be in the form of a buyer's report, for example, corresponding to the changed situation. The notification of change in question can also be a standard message, after receiving which the potential buyer knows that the situation has changed and, to find out about the new situation, can produce a request to show the buyer's report. Correspondingly, a notification of change is transferred through the data network to the potential seller who has placed a sales advertisement, when a new purchase advertisement is placed in the data base, which satisfies the selection conditions that would be used to select the purchase advertisements, if the potential seller, who had placed the said sales advertisement, produced a request to show the seller's report. The notification of change in question can be in the form of a seller's report, for example, corresponding to the changed situation. The notification of change can also be a standard message, after receiving which the potential seller knows that the situation has changed and, to find out about the new situation, can produce a request to show the seller's report.

In the method according to one embodiment of the invention, a notification of change is transferred through the data network to the potential buyer who has placed a purchase advertisement, when a sales advertisement is removed from the data base, which satisfied the selection conditions associated with the said purchase advertisement. Correspondingly, a notification of change is transferred through the data network to the potential seller who has placed a sales advertisement, when the purchase advertisement is removed from the data base, which satisfied the selection conditions associated with the said sales advertisement. The notification of change can be a buyer's or a seller's report or a standard message, corresponding to the changed situation.

In the method according to one embodiment of the invention, a notification of change is sent trough the data network to the potential buyer who has placed a purchase advertisement, when the distinguishing features or other information of the sales advertisement stored in the data base are changed so that the changed sales advertisement satisfies the selection conditions associated with the said purchase advertisement. Correspondingly, a notification of change is sent through the data network to the potential seller who has placed a sales advertisement, when the distinguishing features or other information of the purchase advertisement stored in the data base are changed so that the changed purchase advertisement satisfies the selection conditions associated with the said sales advertisement.

The above-mentioned notifications of change, indicating a change in the situation, can be sent as e-mail messages by means of a mail server connected to the data network. Because of their shortness, the standard notifications of change can also be sent as text or multimedia messages (SMS, MMS) to the mobile phones of the potential sellers and the potential buyers.

In the method according to one embodiment of the invention, the server computer maintaining the automated searching service sends to the potential seller, who has placed the sales advertisement, a seller's report through the e-mail, when a certain predefined time has elapsed from forming the previous seller's report. Correspondingly, the server computer sends to the potential buyer, who has placed the purchase advertisement, a buyer's report through the e-mail, when a certain predefined time has elapsed from forming the previous buyer's report.

The method according to one embodiment of the invention supports public, limited and invisible sales advertisements and public, limited and invisible purchase advertisements. For example, a public sales advertisement is presented in public over the data network on the home page of the quarter maintaining real estate services so that anybody, who has the right to access the home page in question, can look at the said sales advertisement, when they so choose. The distinguishing features and other information of the public sales advertisement are fully or partly presented in public. In this document, being visible in public means that an outside person, who has not themselves placed any purchase or sales advertisements and is not part of the personnel responsible for the functioning of the service, can see the purchase or sales advertisement under examination, when they so desire. For example, the number of outsiders can be limited so that viewing the purchase and sales advertisements that are visible in public is allowed for a fee and/or registration only.

A limited sales advertisement is not shown in public, but its existence is disclosed to those possible buyers only, in whose buyer's reports the sales advertisement in question has been selected. The distinguishing features and other information of the limited sales advertisement are shown fully or partly in the said buyer's reports only.

An invisible sales advertisement is not shown in public and its existence is not disclosed to the potential buyers. The invisible sales advertisement is a data logging device, which can be used by the potential seller to provide preliminary information about the demand for an object on sale without the potential buyers, other potential sellers or outsiders being aware of it. The seller's reports corresponding to the invisible sales advertisement are formed in the same way as the seller's reports corresponding to the corresponding public or limited sales advertisement.

In the method according to one embodiment of the invention, a sales advertisement, which can be public, limited or invisible, is implemented, for example, so that a distinguishing feature-specific or information-specific parameter is connected to each distinguishing feature and other information of the sales advertisement, the potential seller placing the said sales advertisement being able to select, by means of the parameter, between the following alternatives, for example:

the distinguishing feature or other information in question is allowed to be shown both in public and in the buyer's reports,

the distinguishing feature or other information in question is allowed to be shown in the buyer's reports only,

the distinguishing feature or other information in question is not allowed to be shown in public or in the buyer's reports, whereby the distinguishing feature is used only when comparing the distinguishing features of the sales advertisement with the constraint requirements of the purchase advertisement,

the sales advertisement is fully or partly shown in public,

the existence of the sales advertisement is not allowed to be shown in public, i.e., the sales advertisement is limited, if a parameter associated with the sales advertisement, expressing the manner of representation, is placed in a state that does not allow the presentation of the sales advertisement in public, but in the seller's reports only,

the existence of the sales advertisement is not allowed to be shown in public or in the buyer's reports, i.e., the sales advertisement is invisible, if a parameter associated with the sales advertisement, expressing the manner of representation, is placed in a state that does not allow the presentation of the sales advertisement in public or in the buyer's reports.

In the method according to an embodiment of the invention, a purchase advertisement, which can be public, limited or invisible, is implemented, for example, so that a constraint requirement-specific or information-specific parameter is connected to each constraint requirement and other information of the purchase advertisement, by means of which the potential buyer placing the said purchase advertisement can select between the following alternatives, for example:

the constraint requirement or other information in question is allowed to be shown both in public and in the seller's reports,

the constraint requirement or other information in question is allowed to be shown in the seller's reports only,

the constraint requirement or other information in question is not allowed to be shown in public or in the seller's reports, whereby the constraint requirement is only used when comparing the distinguishing features of the sales advertisement with the constraint requirements of the purchase advertisement,

the purchase advertisement is fully or partly shown in public,

the existence of the purchase advertisement is not allowed to be shown in public, i.e., the purchase advertisement is limited, if a parameter associated with the purchase advertisement, expressing the manner of representation, is placed in a state, which does not allow the purchase advertisement to be shown in public but in the seller's reports only,

the existence of the purchase advertisement is not allowed to be shown in public or in the seller's reports, if a parameter associated with the purchase advertisement, expressing the manner of representation, is placed in a state that does not allow the purchase advertisement to be shown in public or in the seller's reports.

The invisible purchase advertisement is a data logging device, by means of which the potential buyer can gain preliminary information about the objects on sale without the potential sellers of outsiders being aware of it. The buyer's reports corresponding to the invisible purchase advertisements are formed in the same way as the buyer's reports corresponding to the corresponding public or limited purchase advertisement.

The method according to the embodiment of the invention under examination provides an opportunity to place anonymous sales and purchase advertisements, wherein the contact information of the potential seller or buyer is not presented in public or in the buyer's or seller's reports. In this document, the anonymous sales and purchase advertisements are referred to as silent sales and purchase advertisements.

In the method according to one embodiment of the invention, the distinguishing feature of a sales advertisement can be determined conditional so that the said distinguishing feature is disregarded and not shown in the buyer's report, if the distinguishing feature in question would cause the sales advertisement not to be selected in the buyer's report corresponding to the purchase advertisement in question. As an example, the sales advertisement has a distinguishing feature defined therein, namely an asking price AP, which is higher than the highest admissible price HAP that is defined as a constraint requirement in the purchase offer. Consequently, as AP>HAP, the sales advertisement under examination does not satisfy the constraint requirements of the purchase advertisement under examination. If the distinguishing feature AP is defined conditional, it is disregarded in the examination and not shown in the buyer's report. Instead of the asking price, for example, “on the basis of offers”, “price negotiable” or the like can be shown in the buyer's report. In a situation according to the example described above, the conditional distinguishing feature AP provides the advantage that the potential buyer, the highest admitted price HAP defined by whom is lower than the asking price AP, may become interested in the object in question on the basis of its other distinguishing features. In later negotiations, the potential buyer and the potential seller may even reach a solution to the price problem, satisfying both parties. On the other hand, another possible buyer, the highest admissible price HAP defined by whom is higher than the asking price AP, most likely considers the fact that the asking price does not exceed the highest admissible price set by them a fact that favours the selection of the object on sale. Consequently, presenting the asking price to such a potential buyer may be profitable to the potential seller. In future, the distinguishing feature of a sales advertisement, which herein is defined conditional, is called a conditional distinguishing feature and a distinguishing feature, which is not conditional, is called an unconditional distinguishing feature.

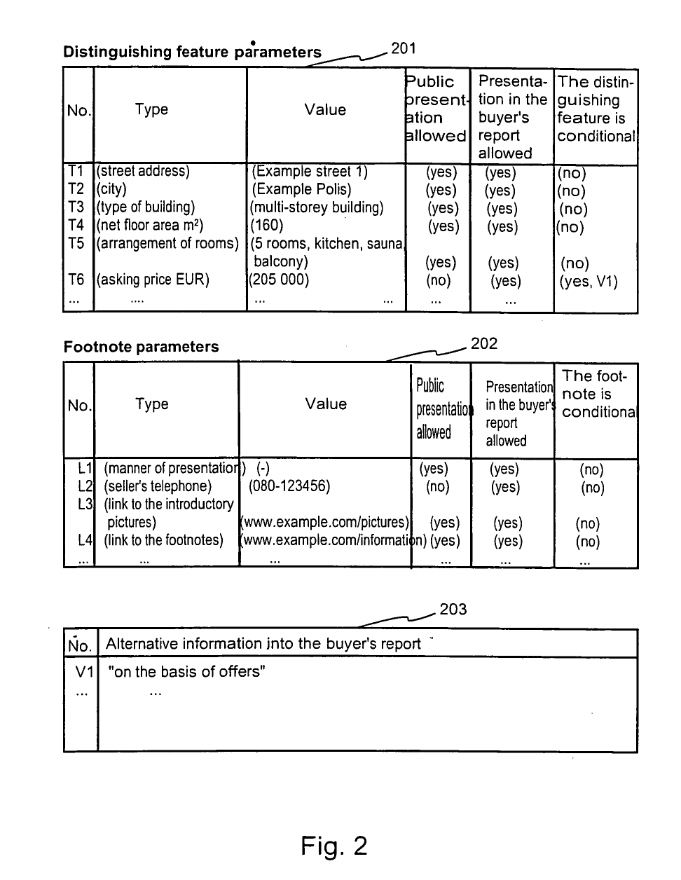

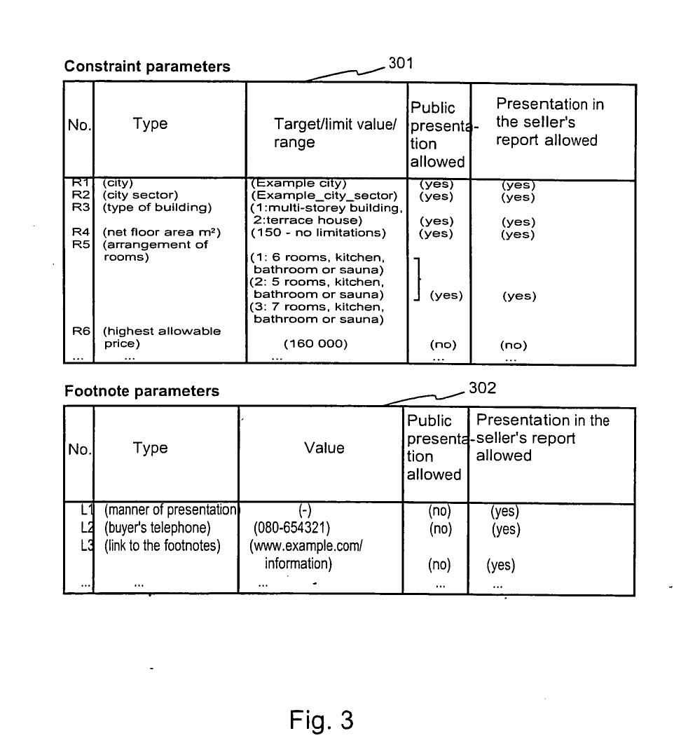

The principle of the sales advertisement used in the method according to one embodiment of the invention is shown in FIG. 2, and the principle of the purchase advertisement is shown in FIG. 3. The information in the parenthesis comprises examples, which are shown in the figure only to illustrate the principle. The line in the parenthesis (−) means that the information in that location has no meaning. The potential seller placing the sales advertisement can select 1 . . . N (N being an integer) different types of distinguishing feature parameters, by means of which they define the distinguishing features of the object on sale, the sales advertisement being compared with the purchase advertisements on the basis of these parameters. Furthermore, the potential seller can select 1 . . . M (M being an integer) different types of footnote parameters, by means of which they define the other information related to the sales advertisement, such as the contact information of the potential seller and whether the sales advertisement is public, limited or invisible. The distinguishing feature or footnote parameters have types indicating the kind of distinguishing feature or other information associated with the sales advertisement the distinguishing feature or footnote parameter under examination represents. The value of the distinguishing feature or footnote parameter indicates the numeric or nonnumeric value of the distinguishing feature or footnote parameter under examination. The types of the distinguishing feature parameters include, for example, the net floor area, the heating method, the year of construction, the dishwashing machine etc. of the object on sale. The values associated with the types in question include “100 m²”, “direct electric power”, “1989”, “none”. The types of the footnote parameters include, for example, a link to additional information in text format, the e-mail address of the seller, etc. The values related to the types in question include, for example, www.esim.com/tiedot (www.example.com/information), myyjä.esimerkki@operaattori.fi (seller.example@operator.fi).

The potential buyer placing a purchase advertisement can select 1 . . . K (K being an integer) different types of constraint parameters, by means of which the constraint requirements for the object being searched for are defined, the purchase advertisement being compared with the sales advertisements on the basis of the constraint requirements. Furthermore, the potential buyer can select 1 . . . L (L being an integer) different types of footnote parameters, by means of which they define the information related to the purchase advertisement, such as the contact information of the potential buyer and whether the purchase advertisement is public, limited or invisible. The constraint or footnote parameters have types indicating the kind of constraint requirements or information related to the purchase advertisement the constraint and footnote parameter under examination represents. The value of the constraint parameter can be a certain eligible feature; for example a desired type of building. The value of the constraint parameter can also comprise a group of alternatives, to which the information about the order of superiority can be attached; for example, the desired type of building is primarily a terraced house but also a single-family house can be considered. Furthermore, the constraint parameter can be a closed or open range; for example, the acceptable net floor area is 150 . . . 350 square meters or 150 . . . “no limitations” square meters.

Table 201 in FIG. 2 shows examples of the distinguishing feature parameters T1-T6 of the sales advertisement, Table 202 shows examples of the footnote parameters L1-L4 of the sales advertisement, and Table 203 shows an example of an alternative piece of information V1 included in the purchase report, which is shown in the buyer's report instead of the value of the conditional distinguishing feature T6, if T6 does not meet the corresponding constraint requirement(s) of the purchase advertisement. The sales advertisement according to the example is public, which is determined by the footnote parameter L1. The telephone number L2 of the potential seller is not shown in public but in the buyer's report only. Furthermore, the footnote parameters contain the web addresses L3 and L4, which in this example are shown both in public and in the buyer's reports, and which contain pictures and written additional information about the object on sale. For example, the written additional information can contain a report on the method of building and/or assessments and comments of the present of previous inhabitants of the building, concerning the house and the environment. The written additional information and/or the pictures can either fully or partly be ready in the data base of the real estate agent or the other quarter maintaining the service, whereby the potential seller does not need to produce this material themselves. For example, photographs taken from outside the building can be ready. In that case, when placing the sales advertisement, the potential seller can include a link to the pictures that are already there, and add to the location indicated by this link the photographs they have taken from inside the flat that is on sale, which most likely are not yet in the data base.

Table 301 in FIG. 3 shows examples of the constraint parameters R1-R6 of the purchase advertisement, Table 302 shows examples of the footnote parameters L1-L3 of the purchase advertisement. The constraint parameters R1 and R2 determine the city and the city sector, where the potential buyer is looking for a suitable object. The constraint parameter R3 defines that the potential buyer is primarily looking for an object in a multi-story building and secondarily one in a terrace house. The constraint parameter R4 defines that the net floor area should be at least 150 square meters. The constraint parameter R5 defines that the most suitable arrangement of rooms be 6 rooms+kitchen+bathroom, the second suitable one is 5 rooms+kitchen+bathroom, and the third suitable one is 7 rooms+kitchen+bathroom. The constraint parameter R7 defines that the price should not exceed 160 000 euros. Except for the highest allowable price (160 000 euros), the above-mentioned information is thus allowed to be shown both in public and in the seller's reports. Thus, the said information of the price limit is used only when comparing the purchase advertisement in question with the sales advertisements. The purchase advertisement according to the example is limited, which is defined by means of the footnote parameter L1. The footnote parameters L2 and L3 represent the telephone number of the potential buyer and a link to the written and/or visual material, where the potential buyer may freely describe their wishes concerning the object they are searching for.

The question related to the pair formed by the sales advertisement and the purchase advertisement: “Do the distinguishing features of the sales advertisement under examination meet the constraint requirements of the purchase advertisement under examination according to a predefined minimum standard?” could be answered by means of the situational information related to the pair and the requirement for suitability. The situational information expresses, on a predefined scale, to what extent the distinguishing features of the sales advertisement under examination satisfy the constraint requirements of the purchase advertisement under examination, and the requirement for suitability describes, how well the distinguishing features of the sales advertisement should meet the constraint requirements of the purchase advertisement for the sales advertisement under examination to be selected in the buyer's report corresponding to the purchase advertisement under examination and, correspondingly, for the purchase advertisement under examination to be selected in the seller's report corresponding to the sales advertisement under examination.

In the method according to one embodiment of the invention, the situational information is a binary piece of information, which indicates only, whether any unconditional distinguishing feature of the sales advertisement under examination breaks the constraint requirements of the purchase advertisement under examination. The suitability requirement in this embodiment is that no unconditional distinguishing feature of the sales advertisement under examination breaks any of the constraint requirements of the purchase advertisement under examination. For example, the distinguishing features of the sales advertisement shown in FIG. 2 satisfy the constraint requirements of the purchase advertisement shown in FIG. 3, if both refer to the same city (example polis=example city) and if the street mentioned in the sales advertisement (Example Street) is located in the right city sector (Example_city_sector). As the asking price information in the buyer's report, the text “on the basis of offers” defined in Table 203 in FIG. 2 is presented, because the asking price (205 000 euros) of the sales advertisement is a conditional distinguishing feature and its value is higher than the highest allowable price of the purchase advertisement (160 000 euros). If the asking price of the sales advertisement were an unconditional distinguishing feature, the suitability requirement for the sales advertisement under examination would not be satisfied, and the said purchase and sales advertisements would not be shown in the corresponding buyer's and sellers reports.

In the method according to an alternative embodiment of the invention, the situational information (is) a range quantity which, on a predefined scale, quantitatively measures the difference of the distinguishing features of the sales advertisement from the constraint requirements of the purchase advertisement. The potential buyer placing the purchase advertisement can set the constraint requirements that describe the desired values of the features of the object being searched for. Any deviations of the distinguishing features of the sales advertisement from these desired values increase the range quantity, the value of which describes how well or how poorly the distinguishing features of the sales advertisement under examination meet the constraint requirements of the purchase advertisement under examination. In the method according to the embodiment, the potential buyer can be offered an opportunity to define the behaviour of the range quantity for each constraint requirement parameter, for which a desired value has been defined. For a numeric distinguishing feature, such as the net floor area or a geographical distance in a certain direction from the desired location, the behaviour of the range quantity can be defined, for example, by means of the growth factor of the range quantity so that Δe=k1 x the deviation, when the deviation is positive, and Δe=k2 x−deviation, when the deviation is negative, wherein Δe is an increase in the range quantity caused by the deviation, and k1 and k2 are the growth factors corresponding to the different directions of the deviation. For the acceptable alternatives of a nonnumeric distinguishing feature, the rates of growth of the range quantity related to the different alternatives can be defined. For example, if the most wanted type of building is a single-family house, the second most wanted one is a terrace house, and the third most wanted one is a multi-story building, a definition can be made that the single-family house does not increase the range quantity, the terrace house increases the range quantity by an amount of Δe1, and the multi-story building increases the range quantity by an amount of Δe1+Δe2. Furthermore, there can be cross dependencies between the different constraint requirements, for example, so that the behaviour of the range quantity in relation to a certain constraint requirement depends on the situation of one or more other constraint requirements. As an example, there is a case, where the potential buyer is primarily looking for a single-family house and has defined that with the price increasing, the range quantity increases by a factor k1 (k1 range units/euro), if the object of the sales advertisement is a single-family house, by a factor k2, if the object of the sales advertisement is a terrace house, and by a factor k3, if the object of the sales advertisement is a multi-story building. One way of offering the potential buyer an opportunity to define free dependencies is to offer him or her a programming interface for compiling a program containing simple control structures, such as IF—THEN—ELSE structures or state machine structures as part of their purchase advertisement. However, there is the disadvantage that, most likely, only a few of the potential buyers would be willing to study how to compile such programs. By means of the above-mentioned mechanisms, the potential buyer placing the purchase advertisement can define the values of the different constraint requirements with respect to one another.

By means of the range quantities, the sales advertisements can be arranged in the order of superiority from the point of view of a certain purchase advertisement. Correspondingly, the purchase advertisements can be arranged in the order of superiority from the point of view of a certain sales advertisement. Other opportunities for forming the order of superiority include the methods based on fuzzy logic, for example. In this embodiment, the suitability requirement can be defined by the potential buyer or seller by means of the settings of the buyer's or seller's reports. In the buyer's or seller's reports, the reporting settings can be used to define that the sales and purchase advertisements belonging to the best of certain relative portions, for example, the best 10% or a certain predefined number of best suitable sales or purchase advertisements are presented.

In the method according to one embodiment of the invention, the situational information related to a new sales advertisement is formed as a response to placing the sales advertisement in question. Correspondingly, the situational information related to a new purchase advertisement is formed as a response to placing the purchase advertisement in question. If the distinguishing features of an existing sales advertisement or the constraint requirements of an existing purchase advertisement are changed, all the situational information related to the changed sales advertisement or purchase advertisement is updated. The suitability requirements can be partly or fully specified for the sales or purchase advertisements. As described above, the formation methods of the situational information can also be partly or fully sales and purchase advertisement-specific. The sales and purchase advertisement-specific suitability requirements can be defined by means of the report settings of the sales and purchase reports.

The selection of the purchase advertisements, carried out after a request to show the seller's report, is simplified and quickened, as the ready-made situational information can be used to clarify, whether the distinguishing features of the sales advertisement under examination meet the constraint requirements or the purchase advertisement in line in accordance with the suitability requirements. Correspondingly, the selection of the sales advertisements, carried out after a request to show the buyer's report is simplified, as the ready-made situational information can be used to clarify, whether the distinguishing features of the sales advertisement in line meet the constraint requirements of the purchase advertisement under examination in accordance with the suitability requirements. One disadvantage in this method is that storage space is needed for storing the situational information.

For example, storing the situational information can be carried out so that a list of purchase advertisements is attached to each sales advertisement, and to each item of the list, information is attached, indicating the extent, to which the distinguishing features of the sales advertisement in question meet the constraint requirements of the purchase advertisement in question. Correspondingly, a list of sales advertisements is attached to each purchase advertisement, and to each item of the list, information is attached, indicating the extent to which the distinguishing features of the sales advertisement in question meet the constraint requirements of the purchase advertisement in question. To save storage space, the lists attached to the sales advertisements can only include those purchase advertisements, the constraint requirements of which are met according to a predefined common minimum criterion. A similar procedure can also be carried out for the lists related to the purchase advertisements. Another possibility is to deal with the situational information related to the pairs formed by the sales and purchase advertisements as individualized objects so that each pair-specific piece of situational information is associated with the information about the sales advertisement and the purchase advertisement, between which the situational information in question is located; for example, situational information A is related to a sales advertisement X and a purchase advertisement Y.

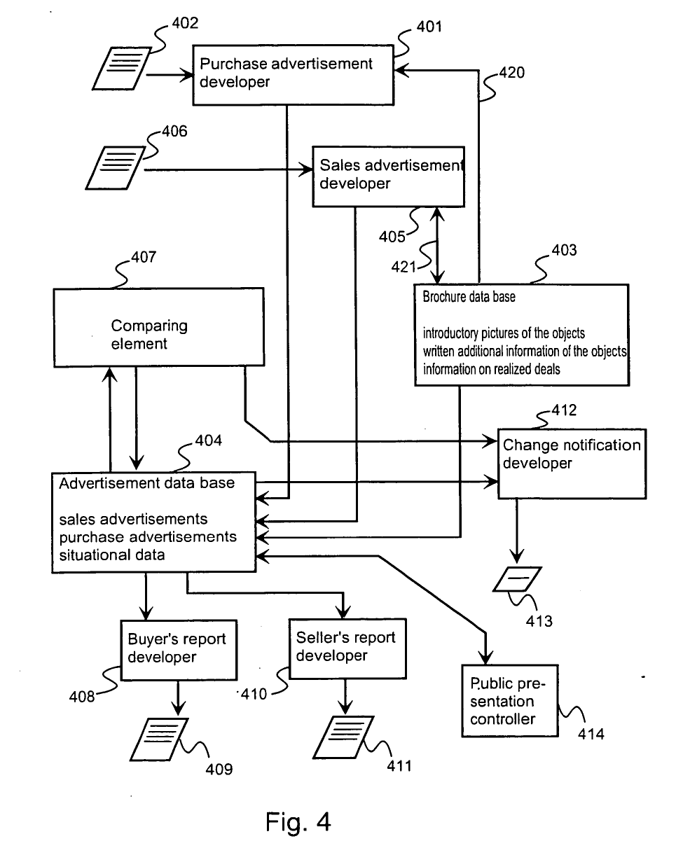

FIG. 4 shows the system according to one embodiment of the invention for offering the automated searching service based on the data network on the real estate market. An advertisement data base 404 contains the sales and purchase advertisements placed into the system. Using a sales advertisement developer 405, the potential seller can produce a new sales advertisement in the said advertisement data base 404. Using a purchase advertisement developer 401, the potential buyer can produce a new purchase advertisement in the said advertisement data base 404. A seller's report developer 410 produces a sellers report 411 corresponding to the sales advertisement as a response to the reporting request produced by the potential seller. A buyer's report developer 408 produces a buyer's report 409 corresponding to the purchase advertisement as a response to the reporting request produced by the potential buyer. A comparing element 407 is arranged to define, whether the distinguishing features of a certain sales advertisement meet the constraint requirements of a certain purchase advertisement to the extent that the sales advertisement in question can be selected to be shown in the buyer's report 409 corresponding to the purchase advertisement in question, and/or that the purchase advertisement in question can be selected to be shown in the seller's report 411 corresponding to the sales advertisement in question.

In the system according to one embodiment of the invention, the sales advertisement developer 405 offers an interface 421, through which the potential seller can feed to a brochure data base 403 visual and written introductory information about the object on sale and its environment, and place in the sales advertisement a link pointing to the said introductory information. Furthermore, through the interface 421, the potential seller can search from the brochure data base the introductory information, which describes the object on sale or its environment and has been placed earlier, and the link pointing to this information can be placed in the sales advertisement. Through the interface 421, for example, the potential seller can further browse through the information about the price level etc. related to the realized deals in the area under examination.

In the system according to one embodiment of the invention, the said comparing element 407 allows the selection of a purchase advertisement in the seller's report 411 and, correspondingly, the selection of a sales advertisement in the buyer's report 409 only, when no distinguishing feature related to the said sales advertisement breaks any of the constraint requirements related to the said purchase advertisement.

In the system according to an alternative embodiment of the invention, the said comparing element 407 is arranged, on the basis of the constraint requirements of the purchase advertisement and the distinguishing features of the sales advertisement, to form a range quantity, which quantitatively measures on a predefined scale the difference of the said distinguishing features from the said constraint requirements, and the said comparing element 407 is arranged, on the basis of the said range quantity, to at least partly define, whether the selection of the said purchase advertisement in the seller's report 411 is allowed, and whether the selection of the said sales advertisement in the buyer's report 409 is allowed.

In the system according to one embodiment of the invention, the seller's report developer 410 is arranged to at least partly define on the basis of one or more parameter settings related to the purchase advertisement, whether the said purchase advertisement is selected in the seller's report 411. Correspondingly, the buyer's report developer 408 is arranged to at least partly define on the basis of one or more parameter settings related to the sales advertisement, whether the said sales advertisement is selected in the buyer's report 409.

In the system according to one embodiment of the invention, the seller's report developer 410 is arranged to define, on the basis of a parameter setting related to the said purchase advertisement, whether the constraint requirement or other information related to the said purchase advertisement is put in the seller's report. Correspondingly, the buyer's report developer 408 is arranged to define, on the basis of a parameter setting related to the said sales advertisement, whether the distinguishing feature or other information related to the sales advertisement is put in the buyer's report 409.

In the system according to one embodiment of the invention, the buyer's report developer 408 carries out a screening function, by means of which the potential buyer can define the kind of information that is shown in the buyer's report 409; such as the maximum number of sales advertisements presented, the highest allowable age of the sales advertisements, etc. Furthermore, the screening function offers the potential buyer an opportunity to make personal demands on the sales advertisements presented in the buyer's report 409. For example, the potential buyer can deny the presentation of the sales advertisements, the distinguishing features of which satisfy the constraint requirements of the purchase advertisement well enough, but which do not directly show the contact information to the potential seller. Correspondingly, the seller's report developer 410 can carry out a screening function, which can be used by the potential seller to define the kind of information that is shown in the seller's report 411; such as the maximum number of purchase advertisements presented, the highest allowable age of the purchase advertisement, etc. Furthermore, the screening function offers the potential seller an opportunity to make personal demands on the purchase advertisements presented in the seller's report 411.

The system according to one embodiment of the invention comprises a public presentation controller 414, which is arranged to determine, on the basis of one or more parameter settings related to the purchase advertisement, whether the said purchase advertisement is presented fully or partly in public. Correspondingly, the public presentation controller 414 is arranged to determine, on the basis of one or more parameter settings related to the sales advertisement, whether the said sales advertisement is presented fully or partly in public. Furthermore, the said public presentation controller 414 is arranged to determine, on the basis of a parameter setting related to the purchase advertisement, whether a certain constraint requirement or other information related to the purchase advertisement is shown in public and, correspondingly, on the basis of a parameter setting related to the said sales advertisement, whether a distinguishing feature or other information related to the said sales advertisement is shown in public.

In the system according to one embodiment of the invention, the comparing element 407 is capable of determining, on the basis of a parameter setting related to the sales advertisement, whether a certain distinguishing feature related to the said sales advertisement is conditional or unconditional, and processing the conditional distinguishing feature in the way described earlier in this document.

In the system according to one embodiment of the invention, after a new sales advertisement has been placed, the comparing element 407 selects, on the basis of the distinguishing features related to the said new sales advertisement and the constraint requirements of the purchase advertisements in the data base, the potential buyers, who have placed a purchase advertisement and to whom a notification of change 413 can be sent, concerning the distinguishing features and the constraint requirements. The notification of change is sent to the potential buyer, who has placed a certain notification of inclination to buy, if the comparing element 407 allows the sending of the notification of change, the parameter settings of the new sales advertisement allow the sending of the notification of change, i.e., the new sales advertisement is public or limited, and the reporting settings corresponding to the said purchase advertisement allow the presentation of the sales advertisement in question. The notifications of change 413 are produced by a change notification developer 412, after which they are sent to the selected potential buyers. The effect of the parameter settings can be clarified by means of the seller's and buyer's report developers before or after the comparison of the distinguishing features and the constraint requirements. For example, the notification of change can be a buyer's or seller's report or a standard message corresponding to the changed situation. The notification of change can be sent, for example, by e-mail or as a text message (SMS) to a mobile phone. Correspondingly, the notifications of change can be sent to the potential sellers selected by a corresponding procedure after a new purchase advertisement has been placed.

In the system according to one embodiment of the invention, after changing a distinguishing feature or other information of the sales advertisement, the comparing element 407 selects, on the basis of the distinguishing features related to the said changed sales advertisement and the constraint requirements of the purchase advertisements in the data base, those potential buyers, who have placed a purchase advertisement and to whom a notification of change 413 can be sent with regard to the distinguishing features and the constraint requirements. A notification of change is sent to the potential buyer, who has placed a certain notification of inclination to buy, if the comparing element 407 allows the sending of the notification of change, the parameter settings of the changed sales advertisement allow the sending of the notification of change, i.e., the changed sales advertisement is public or limited, and the reporting settings corresponding to the said purchase advertisement allow the showing of the sales advertisement in question. The notifications of change 413 are produced by the change notification developer 412, after which they are sent to the selected potential buyers. Correspondingly, the notifications of change can be sent to the potential sellers selected by a corresponding procedure after changing the purchase advertisement.

In the system according to one embodiment of the invention, after removing a sales advertisement, the comparing element 407 selects, on the basis of the distinguishing features related to the said removed sales advertisement and the constraint requirements of the purchase advertisements in the data base, the potential buyers, who have placed a purchase advertisement and to whom the notification of change 413 can be sent with regard to the distinguishing features and the constraint requirements. A notification of change is sent to the potential buyer, who has placed a certain notification of inclination to buy, if the comparing element 407 allows the sending of the notification of change, the parameter settings of the removed sales advertisement allow the sending of the notification of change, i.e., the removed sales advertisement is public or limited, and the reporting settings corresponding to the said purchase advertisement would allow the showing of the sales advertisement in question. The notifications of change 413 are produced by the change notification developer 412, after which they are sent to the selected potential buyers. Correspondingly, the notifications of change can be sent to the potential sellers selected by a corresponding procedure after removing the purchase advertisement.

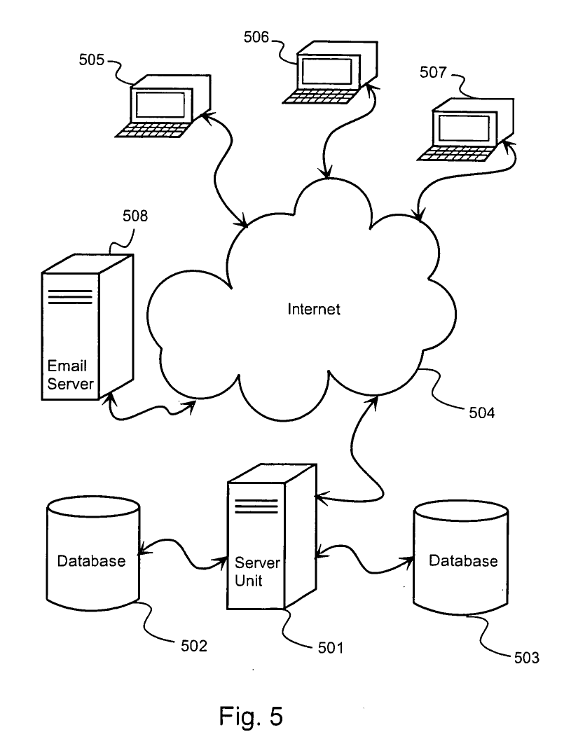

FIG. 5 shows hardware, by which the system presented in FIG. 4 can be implemented for offering the automated searching service based on the data network on the real estate market. The hardware comprises a server unit 501, by which the purchase advertisement developer 401, the sales advertisement developer 405, the comparing element 407, the buyer's report developer 408, the seller's report developer 410, the change notification developer 412 and the public presentation controller 414 shown in FIG. 4 are implemented. Furthermore, the server unit 501 is used to administer duplex data transfer to one or more memory units 502 and 503, which are used to implement the advertisement data base and the brochure data base.

The server unit 501 is used to implement the data lines to the terminal devices 505 to 507 of the users through the data network 504, whereby the potential buyers and sellers and other quarters can, through these data lines, use the purchase advertisement developer, the sales advertisement developer, the buyer's report developer, the seller's report developer, browse through the data bases implemented by one or more memory units 502, 503, and place reporting requests. The data network 504 can be the public Internet and the data lines in question can be implemented by using the TCP/IP protocol. The server unit 501 can further send the seller's and buyer's reports to an e-mail server 508, from where the potential buyers and sellers can retrieve, through the data network 504, the seller's and buyer's reports that belong to the respective quarters, utilizing the conventional email protocols.

In the system according to one embodiment of the invention, the functions described above are implemented using a computer program; the information contained by its programmatic means, such as the state machine structures and the functions, being readable by one or more processors of the server unit 501, and its programmatic means making the said one or more processors carry out the functions described above. The said computer program for offering the searching service operating in the data network on the real estate market contains at least the following programmatic means:

a programmatic means for producing a sales advertisement provided with one or more distinguishing features of the object on sale in the advertisement data base,

a programmatic means for producing, in the advertisement data base, a purchase advertisement provided with one or more constraint requirements of the object being searched for,

a programmatic means for producing a seller's report corresponding to the sales advertisement,

a programmatic means for producing a buyer's report corresponding to the purchase advertisement, and

a programmatic means for determining, on the basis of the distinguishing features of the sales advertisement and the constraint requirements of the purchase advertisement, whether the sales advertisement in question can be selected in the buyer's report corresponding to the purchase advertisement in question, and whether the purchase advertisement in question can be selected in the seller's report corresponding to the sales advertisement in question.

In the system according to an alternative embodiment of the invention, part of the functions described above is implemented using application specific integration circuits (ASIC) designed for a certain function, and part of the functions described above is implemented by the programmatic means. One advantage of the application specific integration circuits is their higher rate of performance than that of the programmable processor.

As is obvious to those skilled in the art, the invention and its embodiments are not limited to the embodiment examples described above but the invention and its embodiments can be modified within the independent claims.

1. A method for providing a searching service operating in a data network on a real estate market, the method comprising:
as a response to placing a sales advertisement provided with one or more distinguishing features of an object on sale, said sales advertisement is stored in a data base,
as a response to placing a purchase advertisement provided with one or more constraint requirements of an object being searched for, said purchase advertisement is stored in the data base,
on the basis of the combined effect of at least one distinguishing feature related to said sales advertisement and at least one constraint requirement related to said purchase advertisement, it is at least partly determined whether a piece of information expressing the existence of said purchase advertisement is presented as a response to a reporting request related to said sales advertisement, and
on the basis of the combined effect of at least one distinguishing feature related to said sales advertisement and at least one constraint requirement related to said purchase advertisement, it is at least partly determined whether a piece of information expressing the existence of said sales advertisement is presented as a response to a reporting request related to said purchase advertisement.

2. A method according to claim 1, wherein the information expressing the existence of said purchase advertisement is presented as a response to the reporting request related to said sales advertisement, and the information expressing the existence of said sales advertisement is presented as a response to the reporting request related to said purchase advertisement only, if no distinguishing feature related to said sales advertisement breaks any of the constraint requirements related to said purchase advertisement.

3. A method according to claim 1, wherein a range variable is formed on the basis of the constraint requirements related to said purchase advertisement and the distinguishing features related to said sales advertisement, which on a predefined scale, quantitatively measures the difference of said distinguishing features from said constraint requirements, and on the basis of which it is at least partly determined, whether the information expressing the existence of said purchase advertisement is presented as a response to the reporting request related to said sales advertisement, and whether the information expressing the existence of said sales advertisement is presented as a response to the reporting request related to said purchase advertisement.

4. A method according to claim 1, comprising at least one of the following:
on the basis of at least one parameter setting related to said purchase advertisement, a determination is at least partly made, whether the piece of information expressing the existence of said purchase advertisement is shown as a response to the reporting request related to said sales advertisement, and
on the basis of at least one parameter setting related to said sales advertisement, a determination is at least partly made, whether the piece of information expressing the existence of said sales advertisement is shown as a response to the reporting request related to said purchase advertisement.

5. A method according to claim 1, comprising at least one of the following:
on the basis of a parameter setting related to said purchase advertisement, a determination is made, whether a constraint requirement or other information related to said purchase advertisement is shown as a response to the reporting request related to said sales advertisement, and
on the basis of a parameter setting related to said sales advertisement, a determination is made, whether a distinguishing feature or other information related to said sales advertisement is shown as a response to the reporting request related to said purchase advertisement.

6. A method according to claim 1, comprising at least one of the following:
on the basis of at least one parameter setting related to said purchase advertisement, a determination is at least partly made, whether the piece of information expressing the existence of said purchase advertisement is shown in a form visible to the public, and
on the basis of at least one parameter setting related to said sales advertisement, a determination is at least partly made, whether the piece of information expressing the existence of said sales advertisement is shown in a form visible to the public.

7. A method according to claim 1, comprising at least one of the following:
on the basis of a parameter setting related to said purchase advertisement, it is determined, whether a constraint requirement or other piece of information related to said purchase advertisement is shown in a form visible in public, and
on the basis of a parameter setting related to said sales advertisement, it is determined, whether a distinguishing feature or other piece of information related to said sales advertisement is shown in a form visible to the public.

8. A method according to claim 1, wherein, on the basis of a parameter setting related to said sales advertisement, it is determined, whether a certain distinguishing feature related to said sales advertisement is conditional or unconditional.

9. A method according to claim 1, wherein, as a response to placing said sales advertisement, it is at least partly determined on the basis of the combined effect of at least one distinguishing feature related to said sales advertisement and at least one constraint requirement related to an older purchase advertisement, whether a notification of change is sent to the potential buyer who has placed said older purchase advertisement.

10. A method according to claim 1, wherein, as a response to placing said purchase advertisement, it is at least partly determined on the basis of the combined effect of at least one constraint requirement related to said purchase advertisement and at least one distinguishing feature related to an older sales advertisement, whether a notification of change is sent to the potential seller who has placed said older sales advertisement.

11. A method according to claim 1, wherein, as a response to a change in the distinguishing feature or other piece of information related to said sales advertisement, it is at least partly determined on the basis of the combined effect of at least one distinguishing feature related to said sales advertisement and at least one constraint requirement related to said purchase advertisement, whether a notification of change is sent to the potential buyer who has placed said purchase advertisement.

12. A method according to claim 1, wherein, as a response to a change in the constraint requirement or other piece of information related to said purchase advertisement, it is at least partly determined on the basis of the combined effect of at least one constraint requirement related to said purchase advertisement and at least one distinguishing feature related to said sales advertisement, whether a notification of change is sent to the potential seller who has placed said sales advertisement.

13. A method according to claim 1, wherein, as a response to the data base to the removal of said purchase advertisement from said data base, it is at least partly determined on the basis of the combined effect of at least one constraint requirement related to said purchase advertisement and at least one distinguishing feature related to said sales advertisement, whether a notification of change is sent to the potential seller who has placed said sales advertisement that was stored in said data base.

14. A method according to claim 1, wherein, as a response to the removal of said sales advertisement from the data base, it is at least partly determined on the basis of the combined effect of at least one distinguishing feature related to said sales advertisement and at least one constraint requirement related to said purchase advertisement, whether a notification of change is sent to the potential buyer who has placed said purchase advertisement that was stored in the data base.

15. A method according to claim 9, wherein said notification of change is an email message.

16. A method according to claim 9, wherein said notification of change is a text or multimedia message (SMS, MMS) that is sent to a mobile phone.

17. A method according to claim 1, comprising at least one of the following:
as a response to storing said sales advertisement in the data base, the distinguishing features related to said sales advertisement are compared with the constraint requirements related to at least one older purchase advertisement, and situational data related to said sales advertisement is formed, showing, on a predefined scale, to what extent the distinguishing features related to said sales advertisement satisfy the constraint requirements related to said older purchase advertisement, and, at least partly on the basis of said situational data, it is determined, whether a piece of information expressing the existence of said older purchase advertisement is shown as a response to the reporting request related to said sales advertisement, and
as a response to storing said purchase advertisement in the data base, the constraint requirements related to said purchase advertisement are compared with the distinguishing features related to at least one older sales advertisement, and situational data is formed, related to said purchase advertisement and showing, on a predefined scale, to what extent the distinguishing features related to said older sales advertisement satisfy the constraint requirements related to said purchase advertisement, and it is determined at least partly on the basis of said situational data, whether the piece of information expressing the existence of said older sales advertisement is shown as a response to the reporting request related to said purchase advertisement.

18. A method according to claim 17, wherein said situational data related to the sales advertisement is updated as a response to a change in the distinguishing feature or other information related to said sales advertisement, and said situational data related to the purchase advertisement is updated as a response to a change in the constraint requirement or other information related to said purchase advertisement.

19. A system for providing a searching service operating in a data network on a real estate market, the system comprising:
an advertisement data base,
a sales advertisement developer for producing a sales advertisement provided with one or more distinguishing features of the object on sale in said advertisement data base,
a purchase advertisement developer for producing a purchase advertisement provided with one or more constraint requirements of the object being searched for in said advertisement data base,
a seller's report developer for producing a sales report corresponding to said sales advertisement,
a buyer's report developer for producing a buyer's report corresponding to said purchase advertisement, and
a comparing element arranged to at least partly determine on the basis of the combined effect of at least one distinguishing feature related to said sales advertisement and at least one constraint requirement related to said purchase advertisement, whether a piece of information expressing the existence of said purchase advertisement is shown in said seller's report and whether a piece of information expressing the existence of said sales advertisement is shown in said buyer's report.

20. A system according to claim 19, wherein said comparing element allows the showing of the piece of information expressing the existence of said purchase advertisement in said seller's report and the showing of the piece of information expressing the existence of said sales advertisement in said buyer's report only, when no distinguishing feature related to said sales advertisement breaks any of the constraint requirements related to said purchase advertisement.

21. A system according to claim 19, wherein said comparing element is arranged to form, on the basis of the constraint requirements related to said purchase advertisement and the distinguishing features related to said sales advertisement, a range quantity, which quantitatively measures on a predefined scale the difference of said distinguishing features from said constraint requirements, and said comparing element is arranged to at least partly determine on the basis of said range quantity, whether the piece of information expressing the existence of said purchase advertisement is shown in said seller's report and whether the piece of information expressing the existence of said sales advertisement is shown in said buyer's report.

22. A system according to claim 19, wherein said seller's report developer is arranged to at least partly determine on the basis of at least one parameter setting related to said purchase advertisement, whether the piece of information expressing the existence of said purchase advertisement is shown in said seller's report.

23. A system according to claim 19, wherein said buyer's report developer is arranged to at least partly determine on the basis of at least one parameter setting related to said sales advertisement, whether the piece of information expressing the existence of said sales advertisement is shown in said buyer's report.

24. A system according to claim 19, wherein said seller's report developer is arranged to determine on the basis of a parameter setting related to said purchase advertisement, whether a constraint requirement or other information related to said purchase advertisement is shown in said seller's report.

25. A system according to claim 19, wherein said buyer's report developer is arranged to determine on the basis of a parameter setting related to said sales advertisement, whether a distinguishing feature or other information related to the sales advertisement is shown in said buyer's report.

26. A system according to claim 19, comprising a public presentation controller, which is arranged to at least partly determine on the basis of at least one parameter setting related to said purchase advertisement, whether the piece of information expressing the existence of said purchase advertisement is shown in a form visible in public, and to at least partly determine on the basis of at least one parameter setting related to said sales advertisement, whether the piece of information expressing the existence of said sales advertisement is shown in a form visible in public.

27. A system according to claim 26, wherein said public presentation controller is arranged to determine, on the basis of a parameter setting related to the purchase advertisement, whether a constraint requirement or other information related to said purchase advertisement is shown in a form visible in public, and to determine, on the basis of a parameter setting related to said sales advertisement, whether a distinguishing feature or other information related to said sales advertisement is shown in a form visible in public.

28. A system according to claim 19, wherein said comparing element is arranged to determine, on the basis of a parameter setting related to said sales advertisement, whether a certain distinguishing feature related to said sales advertisement is conditional or unconditional.

29. A system according to claim 19, wherein said comparing element is arranged to at least partly determine, as a response to placing said sales advertisement, on the basis of the combined effect of at least one distinguishing feature related to said sales advertisement and at least one constraint requirement related to an older purchase advertisement, whether a notification of change can be sent to the potential buyer, who has placed said older purchase advertisement.

30. A system according to claim 19, wherein said comparing element is arranged to at least partly determine, as a response to placing said purchase advertisement, on the basis of the combined effect of at least one constraint requirement related to said purchase advertisement and at least one distinguishing feature related to an older sales advertisement, whether a notification of change can be sent to the potential seller, who has placed said older sales advertisement.

31. A system according to claim 19, wherein said comparing element is arranged to at least partly determine, as a response to a change in the distinguishing feature or other information related to said sales advertisement, on the basis of the combined effect of at least one distinguishing feature related to said sales advertisement and at least one constraint requirement related to said purchase advertisement, whether a notification of change can be sent to the potential buyer, who has placed said purchase advertisement.

32. A system according to claim 19, wherein said comparing element is arranged to at least partly determine, as a response to changing a constraint requirement or other information related to said purchase advertisement, on the basis of the combined effect of at least one constraint requirement related to said purchase advertisement and at least one distinguishing feature related to said sales advertisement, whether a notification of change can be sent to the potential seller, who has placed said sales advertisement.

33. A system according to claim 19, wherein said comparing element is arranged to at least partly determine, as a response to removing said purchase advertisement from the data base, on the basis of the combined effect of at least one constraint requirement related to said purchase advertisement and at least one distinguishing feature related to said sales advertisement, whether a notification of change can be sent to the potential seller, who has placed said sales advertisement.

34. A system according to claim 19, wherein said comparing element is arranged to at least partly determine, as a response to removing said sales advertisement from the data base, on the basis of the combined effect of at least one distinguishing feature related to said sales advertisement and at least one constraint requirement related to said purchase advertisement, whether a notification of change can be sent to the potential buyer, who has placed said purchase advertisement.

35. A system according to claim 29, comprising a change notification developer for sending said notification of change as an email message.

36. A system according to claim 29, comprising a change notification developer for sending said notification of change to a mobile phone as a text or multimedia message (SMS, MMS).

37. A computer program stored in a processor readable means for providing a searching service operating in a data network on a real estate market, the computer program comprising:
a programmatic means for producing a sales advertisement provided with one or more distinguishing features of the object on sale in the advertisement data base,
a programmatic means for producing, in the advertisement data base, a purchase advertisement provided with one or more constraint requirements of the object being searched for,
a programmatic means for producing a seller's report corresponding to said sales advertisement,
a programmatic means for producing a buyer's report corresponding to said purchase advertisement, and
a programmatic means for at least partly determining, on the basis of the combined effect of at least one distinguishing feature related to said sales advertisement and at least one constraint requirement related to said purchase advertisement, whether the piece of information expressing the existence of said purchase advertisement is printed in said seller's report, and whether the piece of information expressing the existence of said sales advertisement is printed in said buyer's report.
